(19) United States
(12) Patent Application Publication
(10) Pub. No.: US 2021/0153014 A1
(43) Pub. Date: May 20, 2021

(54) OFFLINE AUTHENTICATION USING DATA-OVER-SOUND

(71) Applicant: PAYPAL, INC., San Jose, CA (US)

(72) Inventors: Harikrushna Girishbhai Vanpariya, Bangalore (IN); Sushil Jagdish Rakhonde, Bangalore (IN)

(21) Appl. No.: 16/689,653

(22) Filed: Nov. 20, 2019

(51) Int. Cl. H04W 12/06; H04W 12/00

(52) U.S. Cl. CPC H04W 12/06; H04W 12/00504; H04W 12/00503; H04W 12/0013

(57) ABSTRACT

Systems and methods for offline device authentication using data-over-sound include a first device that has limited or no connectivity to the internet but has access to the mobile network. A second device may have internet connectivity. The first device may encode data into an audio format for transmission over sound waves to the second device. The second device may send the data to a service provider via the internet. The service provider may send an authentication message to the first device via the mobile network. The first device may send the authentication message to the second device via data-over-sound so that the second device may send the authentication message to the service provider via the internet. If the received and sent authentication messages match, the service provider may authenticate the first device for the transaction.

### TECHNICAL FIELD

The present disclosure generally relates to computer security and more particularly to systems and methods for offline device authentication using data-over-sound.

### BACKGROUND

Techniques for high rates of data transmission such as WiFi, 4G, 5G, LTE, and various other technologies facilitate the tasks involved in electronic transactions over the internet. A user oftentimes may want to transfer data over the internet, but the user's mobile device may not have access to the high rate of data transmission to which it normally would have access. There exists a need to improve technology related to device authentication in the execution of data transfers when the user's device does not have access to the internet or when the user's device has a limited data transmission rate over the internet.

### BRIEF DESCRIPTION OF THE FIGURES

FIG. 1 illustrates a block diagram of a networked system suitable for implementing authenticating offline transactions in accordance with one or more embodiments of the present disclosure;

FIGS. 2A-2B illustrate a flow diagram of a process for secure offline authentication of a transaction utilizing data-over-sound in accordance with one or more embodiments of the present disclosure;

FIG. 3 illustrates a flow diagram of a process for secure offline authentication of a transaction utilizing data-over-sound in accordance with one or more embodiments of the present disclosure;

FIG. 4 illustrates a block diagram of device-to-device communication using data-over-sound in accordance with one or more embodiments of the present disclosure; and

FIG. 5 illustrates a block diagram of a computer system in accordance with one or more embodiments of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, structures and components are shown in block diagram form in order to avoid obscuring the concepts of the subject technology. One or more embodiments of the subject disclosure are illustrated by and/or described in connection with one or more figures and are set forth in the claims.

The present disclosure describes devices, systems and methods for performing secure offline authentication in transactions using data-over-sound (DoS). In various embodiments, the systems or methods may include a device-to-device communication system. A first device may determine that it does not have any or sufficient internet connectivity to perform a transaction although a user of the first device may want to perform a transaction. A second device within proximity to the first device may have access to the internet. In some cases, the first device may be a user device for a consumer and the second device may be a merchant device (e.g., Point-of-Sale device) for a merchant. Using the data-over-sound techniques described below, the user of the first device may communicate with the second device to perform the transaction although the first device may not have internet connectivity (e.g., offline) or sufficient connectivity to perform the transaction. Note that “offline,” not having internet connectivity or access, internet connectivity being unavailable, and the like also refers to having some but insufficient internet connectivity to perform the transaction. It will be appreciated that the lightweight processing needed to transfer data as DoS has application in reducing electronic device energy consumption in processes that are typically associated with transferring data over conventional high-speed, high-rate wireless technologies.

In some embodiments, the first device may discover nearby devices configured to receive data-over-sound (DoS). The discovery process may include using short bursts of audio (e.g., sound waves) to identify the nearby devices. For example, nearby devices may be devices within 1 centimeter to 100 meters of the first device. The second device, and additional devices, may be identified by the first device in the discovery process. The second device may be operating in a listening mode to facilitate DoS transactions with other nearby devices that are in a discovery mode. The second device may receive the audio bursts, decode the audio bursts, and determine that the decoded audio bursts indicate that the first device is searching for nearby devices to perform a DoS transaction. In response to determining that the first device is searching for nearby devices, the second device may respond with one or more DoS audio bursts with information about the second device that may facilitate establishing a secure DoS communication channel between the first device and second device.

The first device may receive responses from the nearby devices, including the second device, indicating a willingness to establish a connection. The second device may be selected as a recipient for the data-over-sound communication from the first device. A syncing/pairing process between the first device and the second device may be performed to establish a secure DoS connection between the two devices. In some embodiments, the syncing/pairing process may include a handshake where the first device and second device exchange information pertaining to DoS communication protocols between the devices. For example, the Advanced Encryption Standard (AES), Rivest, Shamir, and Adelman (RSA) algorithm, or time-based one-time passwords (TOTP) may be used to establish a secure communication channel. In some cases, as part of the syncing/pairing process, the second device may provide a device identifier to the first device via DoS that the first device may incorporate into DoS messages that will be sent to the service provider, according to various embodiments described herein, so that the service provider may use the device identifier to retrieve relevant information associated with the second device. For example, the service provider may be able to retrieve account information for an account associated with the second device to process the transaction by using the device identifier and comparing it to device identifiers in a database to determine a matching device identifier and a corresponding account.

The user of the first device may input a desired transaction amount for the transaction into a communication application of the first device for DoS transmittal to the second device. The first device may encrypt and encode transaction data including the transaction amount and identity information of the user (e.g., digital identifier, account name, user name, etc.) and send the transaction data over sound waves. For example, the sound may be emitted from one or more speakers of the first device. The sound may propagate over a channel to the second device. In this regard, the channel provides a medium for the sound to propagate. In some cases, the channel may be an acoustic environment such as a room, office, retail store, or meeting room, or other facility for example. In other cases, the channel may also be less acoustic, such as an outdoor space.

The second device may receive the data-over-sound from the first device via a microphone on the second device. The second device may have access to the internet such that the second device may communicate with a service provider server via the internet. The second device may decode the data-over-sound received from the first device and send the decoded data to the service provider server via the internet according to various embodiments.

The service provider server may receive the data from the second device via the internet. In some embodiments, the service provider determines whether a user account associated with the identity information extracted from the data has sufficient funds to execute the transaction. For example, the service provider may compare the transaction amount to the available funds of the user account. If the available fund amount is greater than the transaction amount, there are sufficient funds for the transaction. If the available fund amount is less than the transaction amount, there are insufficient funds for the transaction.

According to various embodiments, if the service provider determines that there are insufficient funds for the transaction amount, the service provider may reject the transaction, stop the transaction, and/or notify the second device (via the internet connection) and/or the first device (via a mobile network) of the insufficient funds for the transaction. If the service provider determines that there are sufficient funds, the service provider may authorize continuation of performance of the transaction.

If the service provider server has authorized continuation of the transaction, the service provider may send an authentication message to the first device via a mobile network (e.g., cellular network). In various embodiments, the authentication message may be a short message service (SMS) text message, multimedia message service (MMS) message, or voice message.

The first device may receive the authentication message from the service provider server via the mobile network. The first device may send the authentication message to the second device via DoS such that the second device may send a request, including the authentication message, to the service provider via the internet to authenticate the user for the transaction by confirming a match between the authentication message received from the second device via the internet to the authentication message sent to the first device via the mobile network. In some cases, the first device may send the authentication message to the second device in the same manner described above using DoS.

The service provider may receive the request for authentication including the authentication message from the second device via the internet. The service provider may check whether the authentication message received from the second device matches the authentication message that the service provider sent to the first device. For example, the service provider may compare strings of the authentication message to determine if there is a match. For example, strings can be compared character by character using an ASCII value of the characters. The comparison may stop when either end of the string is reached, or corresponding characters are not the same. A non-zero value returned in the comparing operation on mismatch may be the difference of the ASCII values of the non-matching characters of the compared strings. In various embodiments, the authentication message may be partitioned into various portions which may include strings. The service provider may compare certain strings of certain portions of the authentication message to a reference string to determine if there is a match. The reference string may be associated with the authentication message sent to the first device via the mobile network.

If the service provider determines that the authentication message received from the second device matches the authentication message that the service provider sent to the first device, the service provider may process the transaction. If the service provider determines that the authentication message received from the second device does not match the authentication message that the service provider sent to the first device, the service provider may reject the transaction for lack of authentication.

While the various examples disclosed herein focus on particular aspects regarding payment transactions, it will be appreciated that the various embodiments disclosed herein may be applied to other types of transactions and arrangements as well.

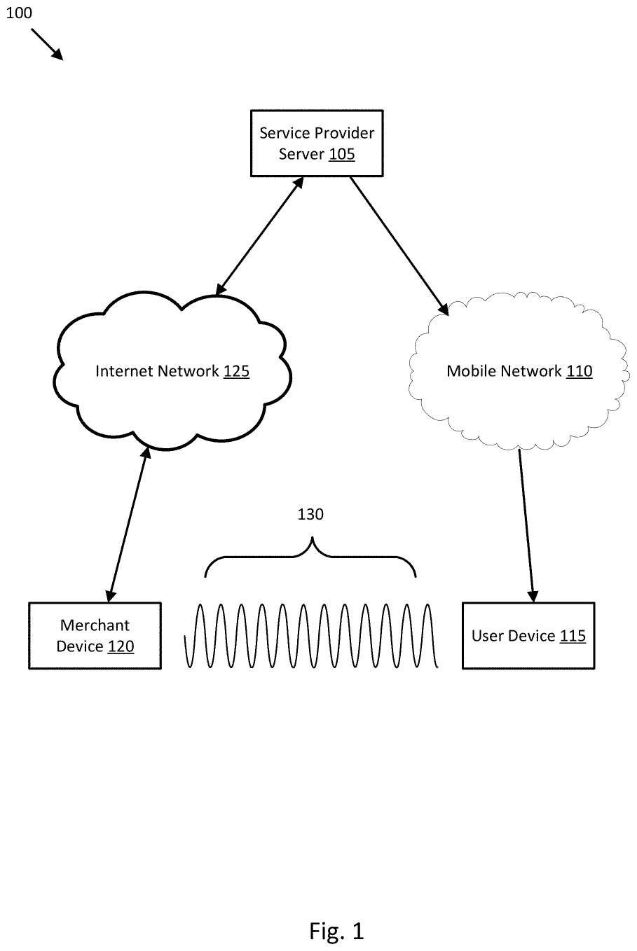

Referring now to FIG. 1, a block diagram is shown of a networked system 100 suitable for implementing a process for securely authenticating offline transactions using data over sound. Networked system 100 may comprise or implement a plurality of servers and/or software components that operate to perform various electronic transaction and/or authentication processes. Exemplary servers may include, for example, stand-alone and enterprise-class servers operating a server operating system (OS) such as a MICROSOFT® OS, a UNIX® OS, a LINUX® OS, or other suitable server-based OS. The server illustrated in FIG. 1 may be combined or separated with additional servers for a given implementation and operations performed may be performed by one or more servers. One or more servers may be in communication with servers of different entities. For example, the one or more servers may perform one or more of the operations described herein via Application Programming Interface (API) calls to applications available on other servers.

System 100 may include service provider server 105, user device 115, and merchant device 120. Service provider server 105 may be in communication with user device 115 via mobile network 110. Service provider server 105 and merchant device 120 may be in communication via internet network 125. For example, service provider server 105 may be maintained by a payment service provider, such as PayPal, Inc. of San Jose, Calif. A user, such as a consumer or payment sender, may utilize user device 115 to perform an electronic transaction such as an e-commerce transaction using a data-over-sound (DoS) capability of user device 115. Further, a user may utilize user device 115 to perform offline transactions via DoS communications with merchant device 120. In various embodiments, the term “transaction” may refer to any suitable action performed using user device 115, including payments, transfer of information, transfer of funds, display of information, etc. For example, the user may utilize user device 115 to initiate a transfer of funds from their PayPal® account to a merchant's PayPal® account.

User device 115, merchant device 120, and service provider server(s) 105 may each include one or more processors, memories, and other appropriate components for performing operations in secure device authentication in offline transactions. For example, such devices may execute instructions such as program code and/or data stored on one or more computer-readable mediums to implement the various applications, data, and steps described herein. Further, such instructions may be stored in one or more computer-readable media such as memories including non-transitory memory or data storage devices internal and/or external to various components of system 100, and/or accessible over internet network 125 as available.

Internet network 125 may be implemented as a single network or a combination of multiple networks used to link devices worldwide over the internet. Mobile network 110 may be a distributed network of base stations over land areas (e.g., cells) that allows devices to transfer radio frequency signals between each other using connection features of the base stations.

User device 115 may be implemented using hardware and software configured for wireless communication over internet network 125 and mobile network 110 and DoS communications with merchant device 120. In some embodiments, user device 115 may be implemented as a personal computer (PC), a smart phone, personal digital assistant (PDA), tablet, laptop computer, wearable device and/or other types of computing devices capable of transmitting and/or receiving data. User device 115 may further include applications as may be desired in particular embodiments to perform various operations discussed herein. For example, the applications may include text message applications and voice message applications that allow the user to send and receive text messages or voice messages via mobile network 110, as well as applications that enable the user to communicate, transfer information, make payments, etc. via internet network 125. User device 115 may include one or more user identifiers which may be implemented, for example, as operating system registry entries, cookies associated with a browser application, identifiers associated with hardware of user device 115, or other appropriate identifiers, such as identifiers for transaction/user/device authentication. In one embodiment, the user identifier may be used by a payment service provider to retrieve a particular account associated with the user and maintained by the payment service provider. User device 115 may include a communications application, with associated user interfaces and communications circuitry, that enables user device 115 to communicate within system 100 (e.g., over network 125, over mobile network 110, via sound waves 130, etc.).

User device 115 may include offline transaction modules for accumulating, storing, encrypting, and/or comparing data associated with a user, a payment, a merchant, a purchase history, a location, and/or other information for securely processing a transaction with user device 115 when user device 115 is not connected to internet network 125. When user device 115 detects that it is reconnected to internet network 125, the offline transaction modules may redirect offline transaction operations to online transaction operations processed by, or in cooperation with, payment provider server 105. For example, during an offline transaction, user device 115 may determine that communications are available via internet network 125 such that user device 115 can communicate directly with service provider server 105 to complete online the remaining portion of an offline transaction. When user device 115 is not connected to internet network 125, the offline transaction modules may perform various operations described herein to provide a payment to a merchant account associated with merchant device 120 without communications over internet network 125.

User device 115 also may collect location data using Global Positioning System (GPS) circuitry to identify a location of user device 115. Other means for collecting location data, such as through WiFi devices, Near-Field Communication (NFC) devices, or the like also may be included in user device 115 for determining a location of user device 115. Thus, user device 115 may determine a current location of user device 115 and/or a history of locations of user device 115 based on the collected location data. For example, a path of travel of the user device 115 may be determined based on the collected location data. In some embodiments, user device 115 may send the location data to service provider server 105 and service provider server 105 may determine a current location of user device 115 based on the location data. In various embodiments described herein, the location data may be used to determine if the user device 115 will have access to the internet at a future time. For example, a path of travel of user device 115 may have a trajectory that leads to a dead zone where internet connectivity is likely to be lost or reduced to the point that transaction processing is likely to be difficult or undoable. In this regard, the location data of user device 115 may be monitored and evaluated at periodic intervals to predict destinations where user device 115 will go in the future based on travel speed, vector information, recently or frequently visited locations, recent location searches in a navigation application or web browser.

In various embodiments, merchant device 120 may be maintained, for example, by a merchant or seller offering various products and/or services or any recipient of funds. More generally, merchant device 120 may be maintained, for example, by an entity that desires to exchange data with user device 115. In some cases, the merchant may have a physical point-of-sale store front. The merchant may be a participating merchant who has a merchant account with the payment service provider. Merchant device 120 may be used as a physical point-of-sale device or for online purchases and transactions.

In some embodiments, merchant device 120 may include a database identifying available products (including digital goods) and/or services (e.g., collectively referred to as items) which may be made available for viewing and purchase by the user.

According to various embodiments, merchant device 120 also may include a checkout application, which may be configured to facilitate the transaction for purchase of goods or services online or at a physical POS or store front. The checkout application may be configured to accept payment information from or on behalf of the user through payment service provider server 105 over network 125. For example, the checkout application may receive and process a payment confirmation from service provider server 105, as well as transmit transaction information to the payment service provider and receive information from the payment provider (e.g., a identity data, and transaction data).

In one or more embodiments, service provider server 105 may be maintained, for example, by an online payment service provider which may provide payment between the user of user device 115 and the operator of merchant device 120. In this regard, service provider server 105 may include one or more payment applications which may be configured to interact with user device and/or merchant device 115 over internet network 125 or mobile network 110 to facilitate the purchase of goods or services, communicate/display information, authenticate devices, and send payments from a user account associated with user device 115. In circumstances in which user device 115 is not connected to internet network 125, user device 115 may perform secure offline authentication operations for a transaction with merchant device 120 and service provider server 105 may receive transaction information associated with the secure offline authentication and may then fund the transaction. For example, service provider server 105 may transfer funds from a user funding source such as a credit card, a bank account, or an account with service provider server 105 to merchant account associated with merchant device 120.

In some cases, service provider server 105 may maintain a plurality of user accounts, each of which may include account information associated with consumers, merchants, and funding sources, such as banks or credit card companies. For example, the account information may include private financial information of users of devices such as account numbers, passwords, device identifiers, user names, phone numbers, credit card information, bank information, or other financial information which may be used to facilitate online transactions by the user. Account information may also include historic information associated with particular transactions (e.g., transaction amount, recipient, whether the transaction was conducted offline or online, location of transaction, etc.).

In various embodiments, service provider server 105 may further include a transaction execution application configured to retrieve account information associated with user device 115 and merchant device 120 for processing and storage in a transaction database. As such, the transaction execution application may store details of an order from individual users, including a funding source used, available funds after the transaction, etc. The transaction execution application may further be configured to execute one or more transactions that have been redirected from a secure offline transaction. For example, the transaction execution application may use a transaction identifier and progress tracker to process an online transaction by continuing to process a remaining portion of a transaction that was previously being executed offline.

In some embodiments, user device 115 may accumulate and store information such as user behavior information, user location history information, user spending pattern information, daily transaction limits, daily transaction number limits, account information, and/or other information that can be used to ensure that, when a user attempts to use user device 115 to perform a transaction when user device 115 is offline, the user is the owner of the user device and/or is authorized to perform the transaction using the device. User device 115 may accumulate and store information such as user behavior information, user location history information, user spending pattern information, daily transaction limits, daily transaction number limits, account information, and/or other information throughout the lifetime of the user device during online or offline operations of user device 115. User device 115 may accumulate and store information such as user behavior information, user location history information, user spending pattern information, daily transaction limits, daily transaction number limits, account information, and/or other information directly or may receive some or all of the information from service provider server 105, which may, in some instances, have accumulated the information (e.g., when offline authentication for transactions is enabled by the user, the above information may be transferred to the user device from the service provider server prior to internet connectivity being disconnected).

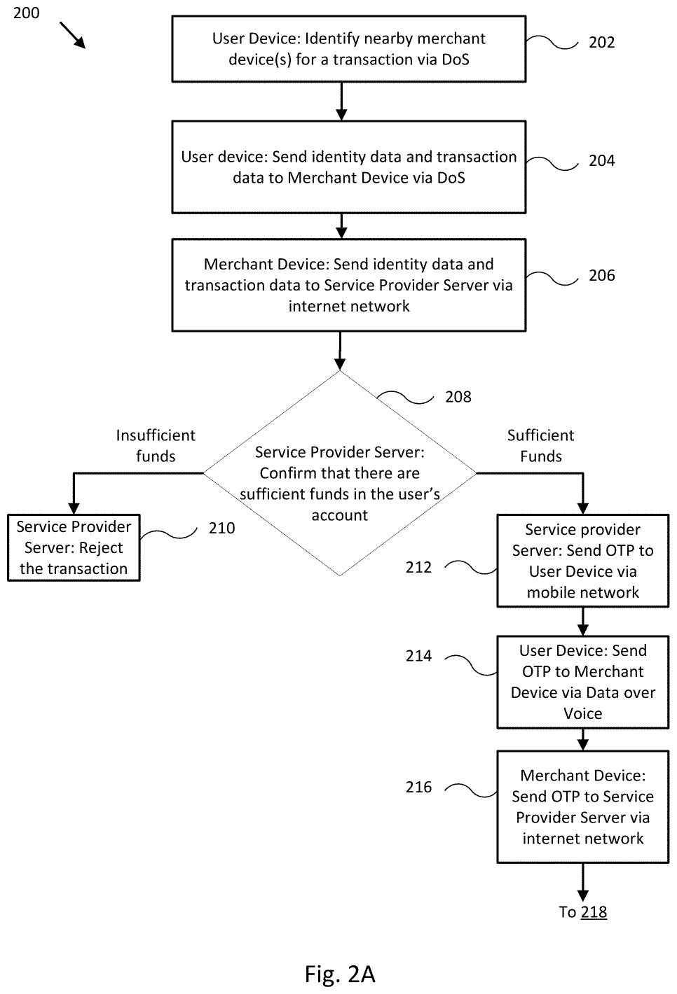

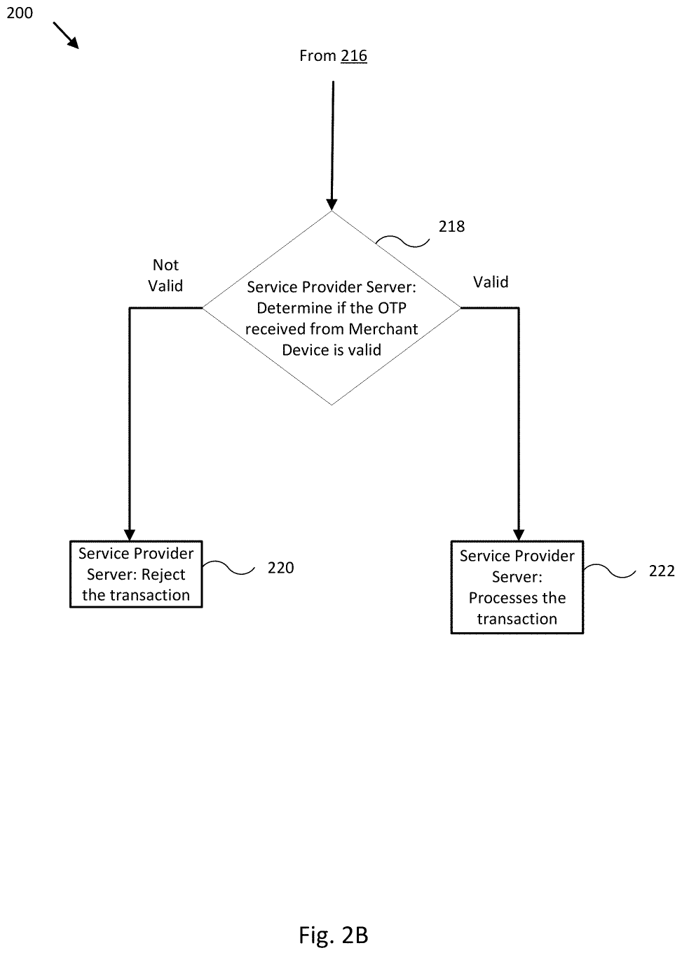

FIGS. 2A-2B illustrate a flow diagram of a process 200 for secure offline authentication of a transaction utilizing data-over-sound in accordance with one or more embodiments of the present disclosure. For explanatory purposes, process 200 is primarily described herein with reference to FIG. 1; however, the process 200 is not limited to FIG. 1. The blocks of process 200 are described herein as occurring in serial, or linearly (e.g., one after another). However, multiple blocks of process 200 may occur in parallel. In addition, the blocks of process 200 need not be performed in the order shown and/or one or more of the blocks of process 200 need not be performed.

Prior to process 200, accounts associated with a service provider may be established. For example, a user may go online to a website or to a physical location of a service provider to apply for and/or set up an account. An authentication profile may be established for each account, which may be used in various embodiments of the present disclosure to authenticate and/or authorize particular users during transactions using data-over-sound.

At block 202, a user device identifies nearby merchant device(s) using Data-over-Sound (DoS). The user device may broadcast short bursts of audio. The audio may be audible, non-audible to humans (e.g., outside the human hearing range of about 20-20,000 hertz), or hidden (e.g., imperceptible modification of certain sounds such as speech or music). The audio bursts may be information encoded into audio format having a certain frequency and broadcasted or sent via a speaker of the user device. The broadcasted audio bursts may be receivable by user equipment within a receiving range of the user device.

In some embodiments, the operations performed at block 202 may be in response to determining that the user device cannot access/connect to the internet. For example, the user device may not have access to WiFi, 3G, 4G, 5G, LTE and various other technologies that permit multi-megabit or gigabit per second wireless transmissions of data. In some cases, when the bit-per-second rate of wireless transmission of data is below a predetermined threshold, the user device may automatically trigger the DoS operations of process 200. In this regard, the threshold may indicate a strength of internet connectivity. The threshold may be adjusted based on the type of transaction, e.g., transactions requiring large amounts of data to be sent may have a higher threshold than transactions requiring lower amounts of data.

According to various embodiments, the user device may check whether internet connectivity is available in response to an application on the user device being initiated (e.g., opened, called). For example, the application may be a payment application or media transfer application. In other embodiments, the user device may check whether internet connectivity is available in response to one or more items being placed in a virtual shopping cart in the application. In one or more embodiments, the user device may check whether internet connectivity is available in response to a checkout process being initiated in the application (e.g., a checkout button being activated, user device navigating to checkout page, digital wallet application being accessed or called via API). In further embodiments, the user device may check whether internet connectivity is available or will be available in the future according to a tracking of a GPS location of the user device and predicted pathways of the user device toward geo-locations where internet connectivity is known to be limited (e.g., poor, weak, absent, etc.). For example, trilateration may be used to monitor a position of the user device over a period of time. Based on a history of tracked positions, the user device's future location may be predicted by extrapolating the positions into a pathway of movement. If a predicted location is known to have limited internet connectivity, for example, by accessing a historic database that stores service provider data related to internet connectivity issues/problems corresponding to certain geo-locations (from data collected from user device experiences in the past), then the user device may automatically begin periodically checking whether internet connectivity is available or may automatically switch to a DoS-preferred data transfer setting in the user device's operating system or applications therein.

In some cases, a transaction history of the user account corresponding to the user device may be analyzed to determine if the user device has been involved in any transactions within the geo-location (e.g., within a predetermined geo-fence) and if the user device has been involved in such transactions, a likelihood score indicating the likelihood of a transaction occurring in the future (such as within a threshold time period) may be calculated. If the likelihood score is greater than a predetermined threshold, a transaction may be predicted to occur in the future, and the internet connectivity monitoring may automatically initiate. For example, if the user goes to a coffee shop location and 12 of the past 21 times the user was at the coffee shop, she has executed a transaction at the coffee shop, then a likelihood score may be calculated as the number of purchase events at the location divided by the total location visits (e.g., 12/21=˜0.57).

In one or more embodiments, if the user device is predicted to be traveling toward a location where internet connectivity is known to be limited, a preauthorization token may be provided to the user device from the service provider prior to the user device entering the location (before internet connectivity becomes limited). In other embodiments, the preauthorization token may be provided to the user device from the service provider without a prediction being made. For example, the preauthorization token may automatically be provided according to an account preference or in response to a request from the user device for a preauthorization token. The user device may include the preauthorization token in the DoS communication to the merchant device as described herein. The service provider may receive the preauthorization token from the merchant device along with identity information to identify a user account of the user device, transaction information, and merchant information to identify a merchant account of the merchant device and complete the transaction without further communications with the user device since the preauthorization token provides authorization by the user of the user device to complete the transaction without further communications from the user device.

Some example cases when a user device may not have access to the internet may include when the user device is (a) inside of a hospital or urgent care facility where medical machines or scanners could be affected by radio signals; (b) inside industrial facilities where industrial machinery can radiate radio frequency interference that affects the user device's ability to access the internet; (c) on mining, military, nuclear, or oil/gas sites that often have explosives on site and/or often prohibit radio frequency use; (d) inside scientific laboratories with delicate instruments that may be sensitive to radio frequency; (e) in buildings that have architectural framework that screens or filters radio frequency; (f) having a hardware and/or software malfunction; and (g) in other various environments where internet connectivity is known to be poor in quality (e.g., below a certain data transfer rate threshold, timing out too many times within a period of time, frequent connectivity disruptions, too many user devices simultaneously using bandwidth intensive services, etc.).

In various embodiments, the operations of process 200 may be triggered based on the user device GPS coordinates moving toward a location such as the above examples, where internet access may be limited or prohibited. For example, if the GPS coordinates are detected to have moved from beyond a threshold distance to within the threshold distance in proximity from such a location, the operations of process 200 may automatically be triggered to be performed instead of a regular transaction process for the user device.

In some embodiments, process 200 includes monitoring availability of the internet. For example, internet access may be checked at periodic intervals during process 200 to determine if the transaction can be redirected to be performed over the internet. According to one or more embodiments, if access to the internet changes from unavailable to available during an ongoing transaction, the user device may redirect the transaction to the service provider server directly over the internet. In some cases, monitoring availability of the internet will be bypassed if the user device is in an offline mode or a data throttle mode in which data transfer rates over the internet are limited to below a threshold data transfer rate.

According to various embodiments, the merchant device(s) within a vicinity of the user device may be in a discovery mode to allow for receipt of the audio bursts from the user device. The merchant devices may receive the audio bursts and, in response, allow the user device to discover and identify the merchant device(s). In some cases, user device 204 may be, may include, or may be part of user device 106 of FIG. 1. In some cases, the merchant device(s) may be, may include, or may be part of merchant device 120 or user device 106 of FIG. 1.

At block 204, the user device sends identity data and transaction data to the merchant device via DoS. The identity data may be an identifier that a service provider uses to identify an account associated with the user of the user device. For example, the identifier may have been established upon account creation with the service provider. In some cases, the identifier may be a hash value of the identifier established for the account. The transaction data may include a transaction amount, transaction item information such as product codes and short identifying descriptions, etc. The user device may encrypt the identity data and transaction data before sending such to the merchant device via DoS. The encryption may be an algorithm that scrambles the identity data and transaction data, making the identity data and transaction impossible to decipher without a key to decrypt.

In some embodiments, the user device may encode the identity data and transaction data using an audio engine to format the identity data and transaction for audio transmission via a speaker of the user device. For example, the identity data and transaction data may be encoded by modulating or watermarking. In some cases, modulation may be used for ad-hoc and real-time communication between the user device and merchant device as it may take an existing source of data and translates it into tones or pulses based on a variety of coding schemes. In other cases, watermarking may be used to change an existing audio signal by incorporating inaudible data into the audio signal. For example, the existing audio signal may be music, and transaction data may be placed in the music as metadata without disturbing the original sound of the music.

In some embodiments, the message sent over the sound waves may be encoded according to an expected message format such that a recipient's decoder may decode the message. For example, the message may include a header and a body. The header may include a preamble of a fixed sequence of frequencies that indicate the start of a message signal. The header may further include a frequency that indicates the length of a payload in the body of the message. The body may include the payload, which may include the relevant data carried by the message. Each symbol of the payload may correspond to a unique frequency in some embodiments. In various embodiments, each symbol may be modulated by an amplitude envelope to prevent discontinuities. A guard interval may be provided between the symbols to reduce an impact of reflections and reverberation as a decoding stage. The body may further include a frequency or sequence of frequencies representing/indicating a checksum for error detection and error correction (e.g., reed-Solomon code for error correction).

In some embodiments, the audio may be formatted to be audible, non-audible to humans (e.g., outside the human hearing range of about 20-20,000 hertz), or hidden (e.g., imperceptible modification of certain sounds such as speech or music). The audio format may include a frequency in the sonic range, ultrasonic range, or between 17 kilohertz and 20 kilohertz in accordance with a desired application of some embodiments. In some cases, the audio format may include a frequency that is distinct/different from the frequency of the audio bursts that the user device broadcasted to discover nearby devices.

In some embodiments, the audio may be formatted to avoid any frequencies in the acoustic environment of the user device. For example, the user device may take a sample of the noise from the environment of the user device and determine a bandwidth that is appropriate for DoS. In a further example, the user device may determine the bandwidth with the least amount of noise, such that DoS can be performed in that bandwidth with minimal interference. In yet a further example, the audio may be formatted such that portions of the transaction data each of a different frequency. For example, the identity information may be transmitted as DoS in a first frequency format while the transaction amount information may be transmitted as DoS in a second frequency format.

The merchant device may receive the audio via a microphone of the merchant device. In one or more embodiments, the merchant device may decode the sound waves of the audio into digital signals prior to the operations at block 206. In various embodiments, the merchant device decodes the sound waves by taking into account various sound interferences. For example, the merchant device decodes the audio by demodulating the message received over the sound waves into computer-readable symbols, removing acoustic artifacts and environmental effects, and error correcting for ultrasound latency, Doppler effect error, deadening materials in the acoustic environment, etc. In some cases, cyclic redundancy check may be used to detect accidental changes (e.g., noise) in the message due to the acoustic artifacts, environmental effects, and other sound propagation phenomena including those above.

In some embodiments, the message received over the sound waves may be decoded according to an expected message format to facilitate timing and synchronization. For example, the message may include a header and a body. The header may include a preamble of a fixed sequence of frequencies that indicate the start of a message signal. The header may further include a frequency that indicates the length of a payload in the body of the message. The body may include the payload, which may include the relevant data carried by the message. The body may further include a frequency or sequence of frequencies representing/indicating a checksum for error detection and error correction (e.g., reed-Solomon code for error correction). With knowledge of the expected message format, a decoder may be able to decode the message received over sound waves into computer-readable digital data.

At block 206, the merchant device sends the identity data and transaction data (received from the user device) to a service provider server via an internet network. The service provider server receives the identity data and transaction data via the internet network. The service provider server may include more than one server according to one or more embodiments. The service provider server may be managed or under the control of the service provider. The service provider server may hold the key to decrypt the identity data and transaction data.

At block 208, the service provider server confirms that there are enough funds in the user's account for the transaction. The service provider may decrypt the identity data and transaction data received from the merchant device using the key. The service provider may compare the identifier of the identity data to identifiers stored in a database accessible by the service provider. The identifier may be used to locate and retrieve account information associated with the identifier. The account information may belong to the account associated with the user of the user device. The service provider server may compare an amount of the transaction data to the funds available for the account to determine if there are sufficient funds for the transaction.

At block 210, the service provider server may reject the transaction for insufficient funds determined at block 208. For example, a transaction amount may be $512 and the available funds for the account may be $26. The service provider server may determine that the transaction amount exceeds the available funds in this example and reject the transaction. If the transaction has been rejected, the service provider may send an SMS, voice, or MMS message to the user device to notify the user that there are insufficient funds in the user's account for the transaction. Similarly, the service provider server may notify a merchant by sending a notification to the merchant device that the transaction has been rejected for insufficient funds.

At block 212, if the service provider server determines that there are sufficient funds in the account, the service provider may send a one-time password (OTP) to the user device via a mobile network. The service provider server may use the OTP to authenticate the user device for the transaction. From the account information determined at block 208, the service provider may determine a device identifier (e.g., telephone number) to which the service provider may send the OTP via the mobile network. The OTP may be an alphanumeric code in some embodiments. In one or more embodiments, the OTP may be encrypted before it is sent to the user device such that it can later be decrypted by the service provider at block 218.

According to various embodiments, the user device receives the OTP over the mobile network from the service provider.

At block 214, the user device sends the OTP to the merchant device via DoS. In some embodiments, the user device may encrypt the OTP and/or encode the OTP using an audio engine to format the OTP for audio transmission via the speaker of the user device. In some cases, the user device encrypts and encodes the OTP in a manner similar to that described above.

The merchant device may receive the audio transmission of the OTP via a microphone of the merchant device. In one or more embodiments, the merchant device may decode the sound waves of the audio transmission of the OTP to error correct and counter the effects of noise and distortion. An analog-to-digital converter of the merchant device may be used to format the sound waves into digital signals prior to the operations at block 216.

At block 216, the merchant device sends the OTP received from the user device to the service provider via the internet network. The service provider receives the OTP via the internet network.

At block 218, the service provider server determines if the OTP received from the merchant device is valid. To validate the OTP, the service provider server may compare the received OTP from the merchant device to the OTP that the service provider sent to the user device at block 212. At block 222, if the received OTP matches the sent OTP, the service provider server authenticates the user device for the transaction and processes the transaction. In some embodiments, the service provider server processes the transaction by identifying a merchant account associated with the merchant and transfers funds in the transaction amount from the user account to the merchant account. In other embodiments, the service provider processes the transaction by communicating with a payment network.

At block 220, if the received OTP does not match the sent OTP, the service provider server rejects the transaction. Upon rejection, the service provider may send a notification via the internet network to the merchant device indicating that OTP was invalid. Similarly, the service provider server may send a notification via the mobile network to the user device indicating that the transaction has been rejected for invalid OTP.

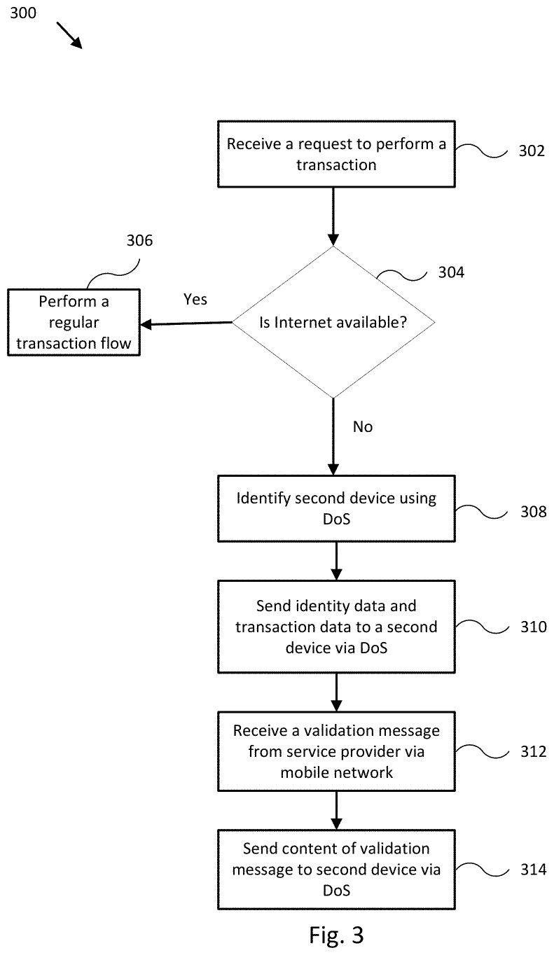

FIG. 3 illustrates a flow diagram of a process 300 for secure offline authentication of a transaction utilizing data-over-sound in accordance with one or more embodiments of the present disclosure. For explanatory purposes, process 300 is primarily described herein with reference to FIG. 1; however, the process 300 is not limited to FIG. 1. One or more of the operations of process 200 may generally be applied in process 300. The blocks of process 300 are described herein as occurring in serial, or linearly (e.g., one after another). However, multiple blocks of process 300 may occur in parallel. In addition, the blocks of process 300 need not be performed in the order shown and/or one or more of the blocks of process 300 need not be performed.

At block 302, a first device may receive a request to perform a transaction with a second device according to one or more embodiments. For example, a user of the first device (first user) may want to transfer funds to a user of the second device (second user). The request may be a demand from the second device in some cases. In other cases, the request may be initiated by an action of a user of the first device.

At block 304, the first device determines whether the internet available. For example, responsive to the payment request, a monitoring module of the first device may check for an internet connection and determine that the first device is not connected to the internet or the internet is otherwise unavailable. A determination that the internet is unavailable may trigger automatic operations to be performed by the first device as further described below.

In some embodiments, the internet may be unavailable due to an inability to connect to an internet network service provided by a service provider. For example, the first device may be in a remote area or in location in which network signals are blocked or a user of the first device may have purposefully disconnected the device from the internet network (e.g., to save battery, protect privacy, etc.). In an example case, the first user may be running low on battery power and may turn off data services (e.g., 3g, LTE, 4G, 5G, etc.) to conserve power, but may still desire to use the first device to perform the transaction. In another example case, the first device may not have data services to connect to the internet while the second device may have data services, and as such, the first user may want to transfer funds to the second user using DoS and the second device's internet connection. In a further example case, the first device may determine that it is unable to connect to the internet as a result of the first device's software/hardware components malfunctioning. For example, the first device may determine that an operating system of the first device is corrupted, or a network interface card of the first device is damaged.

In various embodiments, whether the internet is available may be determined based on the data transfer rate of the first device being below or above a certain threshold rate. For example, a service provider may throttle the data transfer rate for the first device after a certain amount of data has been used by the first device during a period of time. For example, the first device's data transfer rate may be throttled from 100 Mbps to 25 Kbps because the first device exceeded its maximum allotted data of 25 gigabytes per month. As an illustrative example, a threshold of 10 Mbps may be used to determine that the internet is unavailable since the throttled data transfer rate of 25 Kbps is less than 10 Mbps. The threshold data transfer rate may be predetermined for a suitable application of the embodiments discussed herein.

In one or more embodiments, the internet may be determined to be unavailable based on GPS location associated with the first device. The GPS coordinates of the first device may be tracked. Based on the tracked GPS coordinates, the first device may be determined to be moving towards a geo-fence where internet connectivity associated with the geo-fence is known to be below a threshold indicating poor internet connectivity. The geo-fence may be known to be associated with the poor internet activity based on historic data of internet activity associated with the geo-fence. For example, a service provider may keep track of internet connectivity for user devices in the geo-fence and track the difference in internet connectivity inside the geo-fence to internet connectivity outside the geo-fence. In various embodiments, the determination that the first device is moving towards the geo-fence may automatically trigger a DoS protocol as a preferred transaction protocol for the first device. In this regard, one or more of the DoS related operations described herein may be performed automatically in response to the first device moving towards, within a certain distance to, or being within the geo-fence.

In one or more embodiments, the internet may be determined to be unavailable via Bluetooth connectivity or any other proxy connection method (e.g., ZigBee, NFC, etc.). For example, although the first device may be able to connect via Bluetooth to a second device to access the internet by proxy, the first device may determine that the Bluetooth connection is unavailable. For example, the Bluetooth device setting of the first device may be deactivated. In another example, the first device's Bluetooth software/hardware components may be malfunctioning and therefore unable to connect to another Bluetooth-enabled device. In yet another example, the first device may determine that nearby devices do not have Bluetooth capabilities or are not within range to perform a stable Bluetooth connection.

At block 306, if the internet is determined to be available at block 304, the first device may perform the transaction according to a regular transaction flow. For example, the regular transaction flow may be a transaction flow in which the first device connects to the internet to perform the transaction according to some embodiments.

In various embodiments, the regular transaction flow may include a transaction identifier used to identify the transaction and a progress tracker used to track the progress of the ongoing transaction. In some cases, during the regular transaction flow, internet connectivity may be determined/detected as unavailable for one or more reasons such as those discussed above. The transaction may still be performed using DoS according to various embodiments described herein. For example, the regular transaction flow may switch to the operations of block 308 in response to determining that internet connectivity has been lost, disabled, dropped in data transfer rate, etc. In such cases, the transaction identifier and in-progress tracker may be included in the transaction data sent to the second device via DoS at block 310. A service provider may receive the transaction identifier and progress tracker from the second device via the internet connection available on the second device, and the transaction may proceed from where it was stopped due to the internet connectivity becoming unavailable. For example, the service provider may compare the received transaction identifier to current transactions that have been interrupted to find a match between the received transaction identifier and the corresponding transaction that was interrupted. The progress tracker may be used to continue the interrupted transaction where it was interrupted to optimize efficiency in processing the transaction.

In other embodiments, a DoS transaction flow may include a transaction identifier used to identify the transaction and a progress tracker used to track the progress of the ongoing DoS transaction. In some cases, during the DoS transaction flow, internet connectivity may be determined/detected as available (e.g., reactivated, sufficient transfer rate, etc.) for one or more reasons such as those discussed herein. The DoS transaction may transition to be seamlessly performed using the now available internet connectivity. In such cases, the transaction identifier and progress tracker may be included in transaction data sent to the service provider directly via the internet connection from the first device. The service provider may receive the transaction identifier and progress tracker from the first device via the internet connection, and the transaction may continue from the juncture where the internet connectivity became available. For example, the service provider may compare the received transaction identifier to current transactions that have been using a DoS transaction flow to find a match between the received transaction identifier and the corresponding transaction that is currently active in the DoS transaction. The progress tracker may be used to continue the transaction via the internet connectivity and direct communication with the first device.

If the internet is determined to be unavailable at block 304, process 300 moves to block 308 where the first device discovers and identifies nearby devices, including a second device, using DoS. The identification operations and examples described above in reference to block 202 may generally apply at block 308. The second device may be selected among a plurality of other discovered and identified devices in some embodiments. In some cases, the first device may determine whether the second device has the same DoS capabilities as the first device or desired DoS capabilities before further performing a DoS transaction with the second device. In some instances, the first device may capture a sample of the acoustic environment in which the first device is located, and based on characteristics of the acoustic environment, determine an operating frequency for the audio sound waves that will be transmitted between the first device and second device. For example, the first device may determine that music is playing in the acoustic environment, and based on the frequencies of the music, the first device may choose operational audio bursts/sounds to minimize interference in DoS communications with the second device.

At block 310, the first device sends the identity data and transaction data to the second device. The operations and examples described above in reference to block 204 may generally apply at block 310. The first device may encrypt the identity data and transaction data prior to sending such to the second device. The identity data and transaction data may be encoded by an audio engine of the first device such that they are formatted for audio transmission via a speaker of the first device. The audio engine may use a digital-to-analog converter to format the identity data and transaction data. The audio may be formatted to use various frequencies as described herein to optimize performance of the communication to the second device.

At block 312, the first device receives a validation message from the service provider server via a mobile network. The operations and examples described above in reference to block 212 may generally apply at block 312. In various embodiments, the validation message may be an SMS text message or MMS message containing a passcode/PIN/password. In some cases, the validation message may be valid for a limited amount of time or for a single use within a certain time period. In this regard, the validation message may have an expiration characteristic that the service provider assigns to the validation message. The service provider may associate the validation message with a transaction identifier for further authentication. The validation message may include the transaction identifier.

In some cases, the service provider server may be unable to send the validation message to the first device via the mobile network. For example, the service provider may be unable to send the validation message to the first device via the mobile network because (a) the mobile network may be preventing the validation message from being sent from the service provider to the first device due to carrier filters (e.g., A2P filter); (b) the mobile network is encountering routing service errors; (c) the validation message is an SMS message with incorrect encoding (e.g., not Unicode or GSM 3.38). In such cases, the service provider server may determine whether there is a preauthorization permission associated with the first user's account to proceed with the transaction despite being unable to send the validation message to the first device. For example, the first device may provide to the service provider a preauthorization permission for transactions (a) prior to entering a geofence known to have poor internet connectivity; (b) as part of account setup for certain geo-locations known to have poor internet connectivity; (c) with certain second devices (e.g., merchant devices); (d) for periods of time set by user preferences, activated as a temporary account option, or established by default by the service provider. In various embodiments, the service provider server may provide to the first device a preauthorization token in one or more of the above examples. In such embodiments, the first device may provide the preauthorization token to the second device via DoS as described herein along with other information associated with the transaction (e.g., transaction amount, identity information, etc.). When the service provider receives the preauthorization token along with the various other information from the second device, including a merchant identifier (e.g., merchant account identifier or merchant device identifier) the service provider may complete the transaction without further communications to the first device via the mobile network or internet.

In various embodiments, a preauthorization token may be an alphanumeric string. For additional security, the preauthorization token may be time-limited such that is expires after a predetermined amount of time has lapsed. The preauthorization token received by the service provider from the second device may be compared to the preauthorization token that the service provider provided to the first device before internet connectivity was limited/disconnected. For example, a character by character string analysis may be performed to determine if there is a match between the received and sent preauthorization tokens or subparts thereof.

At block 314, the first device sends contents of the validation message to the second device via DoS. The operations and examples described above in reference to block 214 may generally apply at block 314. The second device may send the content of the validation message and a second device identifier to the service provider via the internet according to various embodiments. If the service provider determines that the content of the validation message received from the second device via the internet matches the content of the validation message that the service provider sent to the first device via the mobile network, the service provider may authenticate the first device for completing the transaction. In this regard, the service provider may use the transaction identifier of the validation message to identify an open transaction in which a validation message of the open transaction may be compared to the validation message received from the second device.

In some embodiments, the service provider server may complete the transaction by identifying a second account associated with the second device identifier and transferring funds from the first user's account to the second user's account in a transaction amount determined from the transaction data.

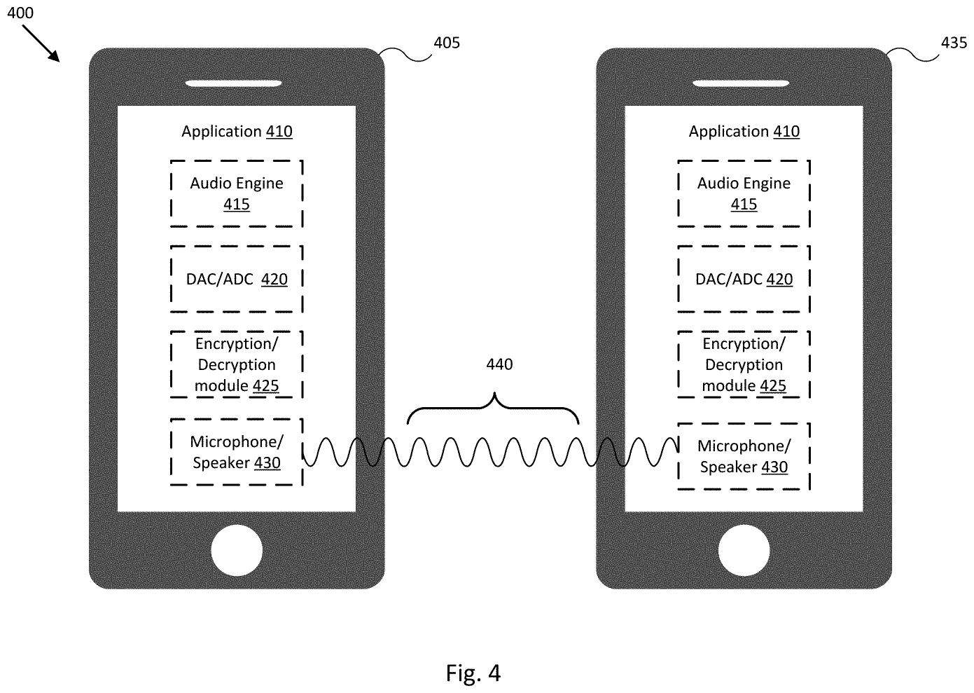

FIG. 4 illustrates a block diagram of a device-to-device communication 400 using data-over-sound in accordance with one or more embodiments of the present disclosure. A first device 405 and a second device 435 each include an application 410, which may control an audio engine 415, a DAC/ADC converter 420, an encryption/decryption module 425, and a microphone/speaker 430. First device 405 or second device 435 may be, may be part of, or may include the various devices described above in reference to FIGS. 1-3. As shown, first device 405 and second device 435 may communicate via sound waves 440 between microphone/speaker 430. According to various embodiments, first device 405 may use sound waves 440 and the internet connectivity available to second device 435 to authenticate first device 405 for performance of a transaction.

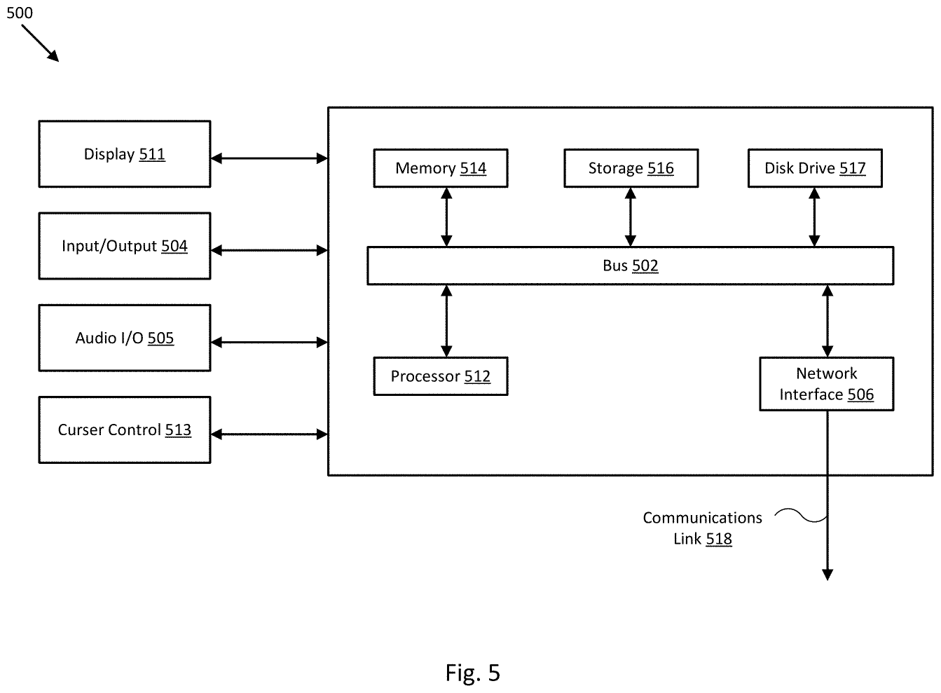

FIG. 5 illustrates a block diagram of a computer system 500 suitable for implementing one or more embodiments of the present disclosure. In various implementations, a user device may comprise a personal computing device (e.g., a personal computer, laptop, smart phone, PDA, Bluetooth device, key FOB, badge, etc.) capable of communicating with the network. The service provider server(s) 105 discussed in reference to FIG. 1 may utilize a network computing device (e.g., a network server) capable of communicating with the network 125 or mobile network 110 of FIG. 1. It should be appreciated that each of the devices utilized by users, entities, and service providers discussed herein may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons or links in a display 511, etc., and sends a corresponding signal to bus 502. I/O component 504 may also include an output component, such as the display 511 and a cursor control 513 (such as a keyboard, keypad, mouse, etc.). Audio input/output (I/O) component 505 may be included to allow a computing system to transmit sound waves according to various embodiments discussed herein. Audio I/O component 505 may include additional hardware/software to allow for the computer system 500 to converting audio signals into digital signals and vice versa. For example, audio I/O component 505 may include one or more microphones or speakers. In some embodiments, the microphones and/or speakers may be distributed about the computing system 500 to allow for full duplex. Full-duplex improves over prior systems as the distributed architecture may allow for sending and receiving data simultaneously in the form of sound waves. A transceiver or network interface 506 transmits and receives signals between computer system 500 and other devices, such as another user device, an entity server, and/or a provider server via network 114. In one embodiment, the transmission is wireless, although other transmission mediums and methods may also be suitable. Processor 512, which may be one or more hardware processors, can be a micro-controller, digital signal processor (DSP), or other processing component, processes these various signals, such as for display on computer system 500 or transmission to other devices via a communication link 518. Processor 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor 512 and other components by executing one or more sequences of instructions contained in system memory component 514. Logic may be encoded in a computer-readable medium, which may refer to any medium that participates in providing instructions to processor 512 for execution. Such a medium may take many forms, including but not limited to, non-volatile media, volatile media, and transmission media. In various implementations, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

1. A system, comprising:
a non-transitory memory; and
one or more hardware processors coupled to the non-transitory memory and configured to read instructions from the non-transitory memory to cause the system to perform operations comprising:
determining, by a first device, that a data connectivity level or an internet connectivity level of the first device is below a threshold needed to perform a transaction with a second device;
in response to the determining that the data connectivity level or internet connectivity level of the device is below the threshold, enabling a Data over Sound (DoS) mode on the first device;
in response to the enabling the DoS mode on the first device, encoding identity data and transaction data into an audio format for transmission via an audio transmission;
transmitting, via a speaker coupled to the first device, the audio transmission to the second device, where in the audio transmission corresponds to the encoded identity data and the encoded transaction data;
receiving, via a mobile network, an authentication message from a service provider server for authenticating the first device for the transaction; and
sending to the service provider server, via the mobile network, a confirmation message responsive to the authentication message, wherein the sending the confirmation message causes the transaction to be completed.

2. The system of claim 1, wherein the operations further comprise encrypting the identity data and the transaction data prior to the encoding.

3. The system of claim 1, wherein the authentication message is a short message service (SMS) text message.

4. The system of claim 1, wherein the data connectivity level is a Bluetooth connectivity level.

5. The system of claim 1, wherein the internet connectivity level comprises a data transfer rate for the internet connectivity.

6. The system of claim 4, wherein the operations further comprise determining that a data service that controls the internet connectivity for the first device has been disabled in a device settings option for the first device.

7. The system of claim 1, wherein the operations further comprise:
broadcasting audio bursts in an environment; and
identifying one or more devices that are in a listening mode, wherein the second device is one of the identified one or more devices.

8. The system of claim 1, wherein the operations further comprise:
determining, based on a tracking of global positioning system (GPS) coordinates of the first device, that the first device is moving towards a GPS location, wherein internet connectivity of the GPS location is known to be below the threshold based on historic data associated with the GPS location; and
in response to the determining that the first device is moving towards the GPS location, activating a data-over-sound protocol in a transaction protocol option for the first device.

9. A method comprising:
determining that a network connectivity level of a first device is below a threshold needed to perform a transaction with a second device;
in response to the determining that the network connectivity level is below the threshold, enabling a Data over Sound (DoS) mode of the first device;
detecting that a second device is capable of receiving an audio transmission as DoS;
in response to the detecting that the second device is capable of receiving the audio transmission, encoding, by the first device, a preauthorization token including identity data and transaction data into a first audio format for broadcasting the audio transmission;
broadcasting, via an audio output component of the first device, the audio transmission to the second device, wherein the audio transmission corresponds to the encoded preauthorization token; and
receiving, subsequent to the network connectivity becoming available, a notification message indicating a completion of the transaction using the preauthorization token.

10. The method of claim 9, further comprising encrypting, by the first device, the identity data and the transaction data prior to the encoding.

11. The method of claim 9, wherein the authentication message is a multimedia messaging service (MMS) message.

12. The method of claim 9, the network connectivity level is an internet connectivity level.

13. The method of claim 12, wherein the internet connectivity comprises a data transfer rate, and wherein the is a data transfer threshold that indicates a strength quality of the internet connectivity.

14. The method of claim 9, wherein the first audio format and the second audio format have different frequencies.

15. A non-transitory machine-readable medium having stored thereon machine-readable instructions executable to cause a machine to perform operations comprising:
determining that an internet connectivity of a first device is below a threshold needed to perform a transaction with a second device;
in response to the determining that the internet connectivity of the first device is below the threshold, enabling a Data over Sound (DoS) mode of the first device;
in response to enabling the DoS mode of the first device, encoding identity data and transaction data into an audio format for communication via an audio transmission;
communicating, via a speaker coupled to the first device, the audio transmission to the second device;
receiving, via a mobile network, an authentication message from a service provider server for authenticating the first device for the transaction; and
sending to the service provider server, via the mobile network, a confirmation message responsive to the authentication message, wherein the sending the confirmation message causes the transaction to be completed by the service provider server.

16. The non-transitory machine-readable medium of claim 15, wherein the operations further comprise encrypting the identity data and the transaction data prior to the encoding.

17. The non-transitory machine-readable medium of claim 15, wherein a frequency of the audio transmission is between 17 kilohertz and 20 kilohertz.

18. The non-transitory machine-readable medium of claim 15, wherein the operations further comprise:
broadcasting audio bursts in an environment to discover nearby devices;
identifying one or more nearby devices that are in a listening mode, wherein the second device is one of the nearby devices; and
displaying a list of the nearby devices in a user interface of the first device for user selection.

19. The non-transitory machine-readable medium of claim 18, wherein the audio bursts have a frequency in an ultrasonic range and the audio transmission has a frequency in a sonic range.

20. The non-transitory machine-readable medium of claim 15,
wherein the operations further comprise:
tracking global positioning system (GPS) coordinates of the first device;
determining, based on the tracking, that the first device is moving towards a geo-fence, wherein an internet connectivity associated with the geo-fence is known to be below the threshold based on historic data of internet connectivity associated with the geo-fence; and
in response to the determining that the first device is moving towards the geo-fence, activating a DoS protocol as a preferred transaction protocol for the first device.
